(19) United States
(12) Patent Application Publication
(10) Pub. No.: US 2023/0035964 A1
(43) Pub. Date: Feb. 2, 2023

(54) TWO STEP AUTHENTICATION SYSTEM FOR SHIPPING

(71) Applicant: CHRIS TURNER, SPRING, TX (US)

(72) Inventor: CHRIS TURNER, SPRING, TX (US)

(21) Appl. No.: 17/877,863

(22) Filed: Jul. 29, 2022

Related U.S. Application Data
(60) Provisional application No. 63/227,181, filed on Jul. 29, 2021.

(51) Int. Cl. G06F 21/35; G06Q 10/08

(52) U.S. Cl. CPC G06F 21/35; G06Q 10/0833; G06F 2221/2111

(57) ABSTRACT

A two-step authentication system and method includes a location address and a non-visual identifier at the location address that is identified and verified via an electronic device. The electronic device may be a scan device at the location address that includes a unique identifier or may also be a GPS location at the address. The system uses one or more electronic devices to capture and verify the address for the delivery of a parcel along with the non-visual identifier assigned to the address location. Communication is provided to a user upon deliver.

### CROSS REFERENCE TO RELATED APPLICATIONS

This application claims the benefit of an earlier filing date and right of priority to U.S. Provisional Application No. 63227181, filed 29 Jul. 2021, the contents of which is incorporated by reference herein in its entirety.

### BACKGROUND OF THE INVENTION

### 1. Field of the Invention

The present application relates to system and method of mail delivery verification, and more particularly to a two-step verification method to ensure first that the package was delivered and secondly that the package was delivered to the correct location.

### 2. Description of Related Art

The use of mail or shipping companies has gained extensive use over the years. Large numbers of consumers choose to shop online and/or have their products shipped to their home or business as opposed to traveling to the store. However, with increasing frequency, all too often these deliveries are delivered to the wrong address. Furthermore, the number of thefts has increased where people take packages off the doorsteps.

In an effort to curtail these issues, shipping companies will make deliveries to a destination and then provide a “confirmation” notice to the customer that the package was delivered. This, however, does not ensure accurate delivery but only notifies the customer when the package was dropped off. Attempts to improve deliveries may include taking a picture of the drop off location and sending that to the customer at the same time as the delivery notice. However, when delivered, the notice is often delayed some time from the time of the actual delivery. At no point does the picture ensure accurate delivery but just verify the location the delivery was made to. If issues are identified with the location, the ability to rectify the delivery is often made impractical as the delivery person has typically already left the site.

Although strides have been made with respect to deliveries made with shipping companies for customers, shortcomings remain. It is desired that a system be provided that is useful prior to delivery to ensure that the delivery of the package is made at the correct location as opposed to post delivery assurances only as seen common in the industry.

### BRIEF SUMMARY OF THE INVENTION

It is an object of the present application to provide a system and method for the authentication and verification of accurate package delivery to the end user and for the delivery personnel / shipping company. The system includes a scanning tool used by the delivery personnel that is able to read and scan a scan device at the drop off location. The scan device is a set with a unique identifier that is transmitted or read by the delivery personnel upon delivery and verified with one provided by the user upon order.

It is a further object of the present application that the two step verification may be done through the use of a particular GPS (global positioning system) location. The system is designed to not rely wholly upon just an address.

Upon delivery the delivery personnel approaches the designated address, takes any pictures or signatures necessary, and makes a second verification either through one or both of GPS coordinates and/or the scanning of a scan device at the location. The system is configured to provide communication with the shipping company and user of such delivery and verification methods used.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a schematic of an electronic system for use with the authentication system according to the present application.

FIG. 2 is a chart of the relationship of the four parties involved with the authentication system of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer’s specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The two-step authentication system 101 for shipping as described in accordance with the present application is configured to facilitate accurate deliveries of mail and packages (i.e. a parcel) to a receiver/user. The authentication system 101 of the present application is used between a shipping company 201 and a package receiver, or user 203. The shipping company uses a delivery personnel to make the package/ mail/envelope delivery to the user at a particularly designated drop off location. System 101 is used to provide a two-step authentication procedure to ensure deliveries are made to the precise location it is supposed to be delivered at. The system 101 is also operable with current methods, practices, and systems used by shipping companies; and is meant to further facilitate and enhance delivery performance.

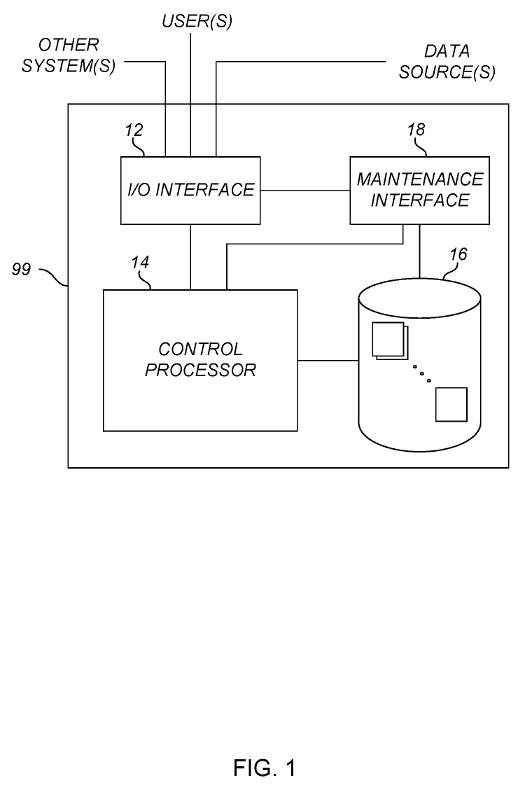

Referring now to FIG. 1 in the drawings, a schematic of an electronic system 99 is shown. System 99 is configured to represent any number of different electronic devices, networks, communication devices, and more that are used to communicate and store and process information. Shipping companies often utilize various electronic devices to track movement of the delivery personnel and locations of packages/parcels. System 99 may represent such devices and may represent additional functionality with existing devices.

As noted, FIG. 1 illustrates an exemplary two-step authorization system 99 for providing precise delivery locations and accurate authentication of the delivery site. The authorization system 99 includes an input/output (I/O) interface 12, an optimization engine 14, a database 16, and a maintenance interface 18. Alternative embodiments can combine or distribute the input/output (I/O) interface 12, optimization engine 14, database 16, and maintenance interface 18 as desired. Embodiments of the authorization system 99 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer’s non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore, the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the authorization system 99. The I/O interface 12 can be configured for allowing one or more users to input information to the authorization system 99 via any known input device. Examples can include a keyboard, mouse, touch screen, microphone, scanning device and/or any other desired input device. The I/O interface 12 can be configured for allowing one or more users to receive information output from the authorization system 99 via any known output device. Examples can include a display monitor, a printer, a speaker, and/or any other desired output device. The I/O interface 12 can be configured for allowing other systems to communicate with the authorization system 99. For example, the I/O interface 12 can allow one or more remote computer(s) to access information, input information, and/or remotely instruct the authorization system 99 to perform one or more of the tasks described herein. The I/O interface 12 can be configured for allowing communication with one or more remote data sources. For example, the I/O interface 12 can allow one or more remote data source(s) to access information, input information, and/or remotely instruct the authorization system 99 to perform one or more of the tasks described herein.

The database 16 provides persistent data storage for authorization system 99. While the term “database” is primarily used, a memory or other suitable data storage arrangement may provide the functionality of the database 16. In alternative embodiments, the database 16 can be integral to or separate from the authorization system 99 and can operate on one or more computers. The database 16 preferably provides non-volatile data storage for any information suitable to support the operation of the authorization system 99.

The maintenance interface 18 is configured to allow users to maintain desired operation of the authorization system 99. In some embodiments, the maintenance interface 18 can be configured to allow for reviewing and/or revising the data stored in the database 16 and/or performing any suitable administrative tasks commonly associated with database management. In some embodiments, the maintenance interface 18 can be configured to allow for maintenance of the optimization engine 14 and/or the I/O interface 12. This can include, for example, software updates and/or administrative tasks such as security management and/or adjustment of certain tolerance settings.

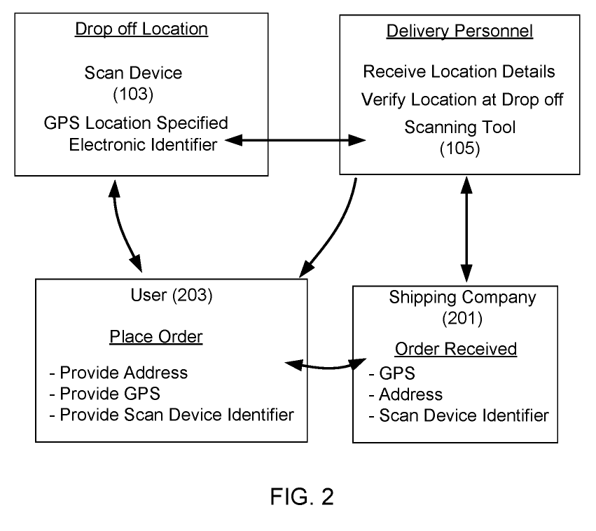

Referring now also to FIG. 2 in the drawings, a chart of the overall system 101 is provided. In the process of delivering a package/parcel there are at least 3 distinct parties involved, namely the user at the drop off location, the shipping company, and the delivery personnel. An order is placed for a package/parcel to be delivered. The shipping company notes an address to be delivered to and an address to be picked up from.

A key of system 99 is the manner in which it ensures accurate delivery of the package/parcel (package). Whereas in legacy approaches, a delivery personnel uses an address only to deliver a package, system 101 permits the delivery personnel to verify accuracy of the location with a GPS location. This is very useful as it is common for it to be difficult to always ascertain the exact site of an address. Reliance only upon an address leads to errors with missed deliveries occurring.

In operation, the precise spot for the delivery can be determined via one of two methods: 1) by a provided GPS location by the user; and 2) via a scan device 103 that has a unique identifier. The particular method is passed on to the delivery personnel which can verify the location, in association with the address, that the location is accurate. In this manner both the address and GPS location is used to provide accuracy. Conversely, the address and the scan device may be used. Likewise, any combination of the address, scan device, and GPS location may be used. Delivery personnel can still take pictures and provide notifications to the user that the delivery occurred.

System 101 may use existing tools and devices of the shipping company or may further include standalone auxiliary/supplemental devices used by the user and the delivery personnel. For example, system 101 may include a GPS scan device set at the delivery location to provide a signal associated with a precise location. This scan device can either emit a signal (i.e. RFID) or be scannable through a device of the shipping company (i.e. scanning tool 105). The device at the delivery location would provide verification of the location through GPS means.

The delivery personnel may use a scanning tool 105 configured to read and communicate with the scan device 103 of the user. This information may be related to the shipping company to assist in confirming accurate delivery. It is noted that the scan device of the user does not have to relay the GPS location but can be any particular identifier that is associated with a known GPS location. The shipping company may have a profile for a user with the GPS and known identifier for instance.

In other embodiments, possibly no GPS scan tool is located at the delivery location for scanning or reading. The delivery personnel may have a GPS coordinate system that monitors the location of the delivery personnel and can verify that the delivery personnel is at the correct spot. This saves the need of a scan device at the delivery location.

The current application has many advantages over the prior art. It is important to note that use of system 101 can assist in confirming accurate delivery prior to the delivery personnel leaving. The GPS location may be verified as part of the delivery process. A scan device may be located at the delivery location having a unique identifier readable by the delivery personnel to confirm accurate drop off location. It is further understood that a location identifier and/or the GPS may be used independent of the other. System 101 may work with either or both. A benefit is increased delivery performance, saved time, and less frustration by the user.

For purposes herein, it is important to note that the use of the GPS location or the scan device identifier are configured to be non-visual identifiers that are provided by the user to the shipping company. A non-visual identifier is a unique identification associated with a specific location that is beyond visual recognition. For example, the mere taking a picture of the drop location is insufficient as it does no more than identify the location of a delivery and not actually verify accuracy of the drop off location. The non-visual identifier can be the GPS location where the delivery personnel capture and verify the GPS point at the address with that provided by the user. Additionally, the non-visual identifier is the scan device which may be a uniquely assigned number, signal, or identity also provided by the user to the shipping company. The two step verifications may be transmitted to the user upon delivery to show accurate delivery.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A two-step verification system for parcel deliveries, comprising:
a designated drop off location address for delivery of a parcel;
a scan tool used by a delivery personnel; and
a scan device at the drop off location, the scan tool is configured to read the scan device and confirm a particular location for the parcel in combination with the designated drop off location address, the scan device providing a unique identifier provided by the user.

2. The system of claim 1, wherein the scan device is associated with a particular GPS location known to the delivery personnel.

3. The system of claim 1, wherein the scan device has a unique identifier configured to be captured by the scanning tool.

4. The system of claim 1, wherein the scan device is configured to emit a signal.

5. The system of claim 1, wherein the scan device emits a radio frequency.

6. A two-step verification system for parcel deliveries, comprising:
a designated drop off location address for delivery of a parcel;
a scan tool used by a delivery personnel; and
a scan device at the drop off location, the scan tool is configured to read the scan device and confirm a particular location for the parcel in combination with the designated drop off location address, the scan device providing a particular GPS location provided by the user.

7. The system of claim 6, wherein the scan device has a unique identifier configured to be captured by the scanning tool.

8. The system of claim 6, wherein the scan device is configured to emit a signal.

9. The system of claim 6, wherein the scan device emits a radio frequency.

10. A method of verifying the accuracy of a delivery, comprising:
obtaining a location address for delivery;
obtaining a non-visual identifier for the location address;
arriving at the location for delivery;
capturing a unique non-visual identifier at the location; and
verifying the location address and the unique non-visual identifier match.

11. The method of claim 10, wherein the non-visual identifier is a GPS location.

12. The method of claim 11, wherein the non-visual identifier also includes a unique identifier assigned to the location address.

13. The method of claim 12, wherein the scan device emits a radio frequency.

14. The method of claim 10, wherein the non-visual identifier is a unique identifier assigned to the location address.

15. The method of claim 10, wherein the non-visual identifier is obtained through electronic communication with a scan device.

16. The method of claim 15, wherein the scan device emits a radio frequency.
